(19) United States
(12) Patent Application Publication
(10) Pub. No.: US 2024/0037194 A1
(43) Pub. Date: Feb. 1, 2024

(54) THIRD-PARTY ACCOUNT CREATION WITH AUTHENTICATION

(71) Applicants: David Dominic MORROCCO, Annapolis, MD (US); John ESTES, III, McLean, VA (US)

(72) Inventors: David Dominic MORROCCO, Annapolis, MD (US); John ESTES, III, McLean, VA (US)

(21) Appl. No.: 17/875,102

(22) Filed: Jul. 27, 2022

(51) Int. Cl. G06F 21/30; G06F 21/62; G06Q 50/16

(52) U.S. Cl. CPC G06F 21/305; G06F 21/6209; G06Q 50/16

(57) ABSTRACT

Embodiments disclosed are directed to a computing system that performs steps for third-party account creation with an authentication implementation that authenticates a third-party user while avoiding the need for the third-party user to create a password-protected account. The computing system generates a service request associated with an entity and a digital item of record stored in a records database. The computing system then generates a first unique key associated with the entity and the digital item of record and embeds the first unique key as a first clickable link in the service request. Subsequently, in response to receiving an electronic indication that the entity has clicked the first clickable link, the computing system verifies that an identity of the entity is authentic based on the first unique key.

### TECHNICAL FIELD

Embodiments relate to user authentication, specifically a system that utilizes one or more unique keys to authenticate a user without creating a password-protected account.

### BACKGROUND

Online portals have become pervasive for managing digital items of record, such as real estate listings. In one example, real estate agents may use such portals to manage their listings and create requests for services such as photography, landscaping, painting, plumbing, repairs, home inspections, and other services. However, when these service requests are sent out to vendors, each vendor must create a username and password to access the portal and view the requests, increasing the computational complexity associated with the request and decreasing the vendor's likelihood of accepting the request.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art to make and use the embodiments.

FIG. 1 is an example system for authenticating a user without creating a password-protected account according to some embodiments.

FIGS. 2A, 2B, and 2C illustrate an example process flow for an example system for authenticating a user without creating a password-protected account according to some embodiments.

FIG. 3 is an example method for authenticating a user without creating a password-protected account according to some embodiments.

FIG. 4 is an example architecture of components implementing an example system for authenticating a user without creating a password-protected account according to some embodiments.

### DETAILED DESCRIPTION

Embodiments disclosed herein relate to systems and methods for third-party account creation with an authentication implementation that authenticates a third-party user while avoiding the need for the third-party user to create a password-protected account. Generally, a principal can request service for a digital item of record (e.g., an item in a listing) stored in a records database. In one illustrative and non-limiting example relating to a real estate context, these third-party users can be third-party service providers (also referred to herein as “vendors”) who would need access to a property, allowing them to easily navigate the platform without disrupting their normal workflow by creating an account, setting up a password, and performing other actions, all just to respond to a request. As a result, real estate agents can use the real estate portal disclosed herein to manage their listings and create enhanced requests with integrated authentication for services such as photography, landscaping, painting, plumbing, repairs, home inspections, and other services. Similarly, other principals in other non-limiting industries (e.g., event planning, weddings, creative services, etc.) can request services from vendors without the vendors having to create an account. When these enhanced service requests with integrated authentication are sent out to vendors, each vendor does not need to create a username and password to access the portal and view the requests, decreasing the computational complexity associated with the service request and increasing the vendor's likelihood of accepting the service request.

The following embodiments are described in sufficient detail to enable those skilled in the art to make and use the disclosure. It is to be understood that other embodiments are evident based on the present disclosure, and that system, process, or mechanical changes may be made without departing from the scope of an embodiment of the present disclosure.

In the following description, numerous specific details are given to provide a thorough understanding of the disclosure. However, it will be apparent that the disclosure may be practiced without these specific details. In order to avoid obscuring an embodiment of the present disclosure, some circuits, system configurations, architectures, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an embodiment of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claim section below, the module or unit is deemed to include hardware circuitry for the purposes and the scope of the system or apparatus claims.

The term “service” or “services” referred to herein can include a collection of modules or units. A collection of modules or units may be arranged, for example, in software or hardware libraries or development kits in embodiments of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface (API) to facilitate the execution of functions of the system.

The modules, units, or services in the following description of the embodiments may be coupled to one another as described or as shown. The coupling may be direct or indirect, without or with intervening items between coupled modules, units, or services. The coupling may be by physical contact or by communication between modules, units, or services.

System Overview and Function

The systems and methods disclosed herein pertain generally to service industry applications for third-party account creation with an authentication implementation that authenticates a third-party user while avoiding the need for the third-party user to create a password-protected account. For example, a principal can create a request for a third-party service provider to perform a service for a digital item of record (e.g., an item in a listing) stored in a records database. In one illustrative and non-limiting example relating to a real estate context, a real estate listing agent (corresponding broadly to a second entity) can create a request for a third-party vendor (corresponding broadly to a first entity) to perform a service for a property in a real estate listing stored in a real estate listings database. In addition, the embodiments disclosed herein are applicable to other industries and to solving other types of problems. For example, in a creative marketplace context, a patron can create a request for a third-party artist to create a painting for an image in a classified listing stored in a creative marketplace listings database. As a result, the third-party service provider can easily navigate the platform to view and accept a request without having to create an account, set up a password, or perform other actions.

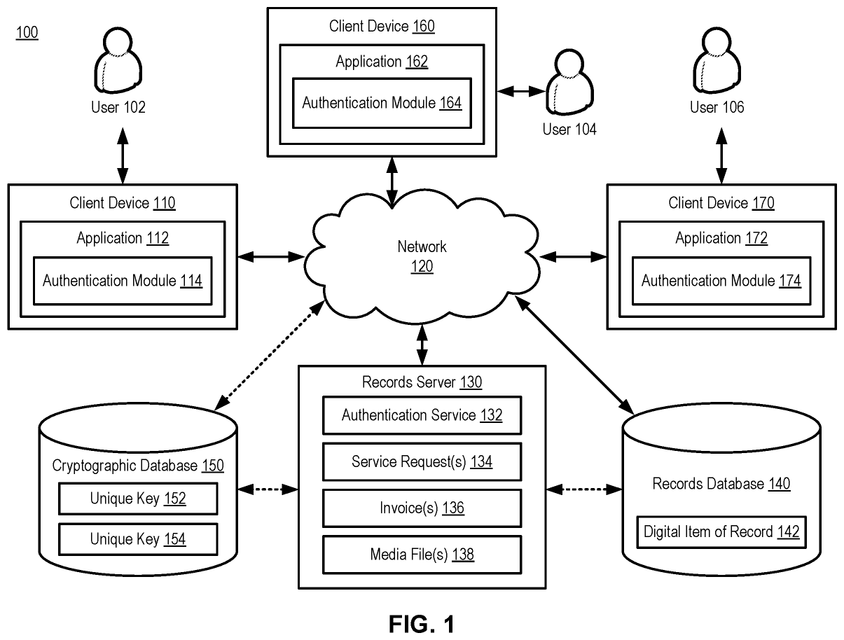

FIG. 1 is an example system 100 for authenticating a user without creating a password-protected account according to some embodiments. In several embodiments, system 100 can include a client device 110 associated with a user 102 (e.g., a principal such as a customer or a real estate seller), a client device 160 associated with the user 104 (e.g., the principal's agent such as a real estate listing agent or seller's agent), a client device 170 associated with a user 106 (e.g., a service provider such as a vendor of a real estate service such as photography, landscaping, painting, plumbing, repair, etc.), a network 120, a records server 130, a records database 140, and a cryptographic database 150. In several embodiments, the client device 110 can further include an application 112 which, in several embodiments, includes an authentication module 114 having access to a plurality of device attributes stored on, or in association with, the client device 110. In several embodiments, the client device 160 can further include an application 162 which, in several embodiments, includes an authentication module 164 having access to a plurality of device attributes stored on, or in association with, the client device 160. In several embodiments, the client device 170 can further include an application 172 which, in several embodiments, includes an authentication module 174 having access to a plurality of device attributes stored on, or in association with, the client device 170. In several embodiments, the records server 130 can further include an authentication service 132.

The client device 110, the client device 160, and the client device 170 may be any of a variety of centralized or decentralized computing devices. For example, one or more of the client device 110, the client device 160, and the client device 170 may be a mobile device, a laptop computer, or a desktop computer. In several embodiments, one or more of the client device 110, the client device 160, and the client device 170 can function as a stand-alone device separate from other devices of the system 100. The term “stand-alone” can refer to a device being able to work and operate independently of other devices. In several embodiments, the client device 110, the client device 160, and the client device 170 can store and execute the application 112, the application 162, and the application 172, respectively.

Each of the application 112, the application 162, and the application 172 may refer to a discrete software that provides some specific functionality. For example, the application 112, the application 162, and the application 172 each may be a mobile application that allows the user 102, the user 104, and the user 106, respectively, to perform some functionality. The functionality can, for example and without limitation, allow the user 102, the user 104, and/or the user 106 to perform service transactions with the records server 130. In other embodiments, one or more of the application 112, the application 162, and the application 172 may be a desktop application that allows the user 102, the user 104, and/or the user 106 to perform the aforementioned functionalities.

In several embodiments, the client device 110, the client device 160, and the client device 170 can be coupled to the records server 130 via a network 120. The records server 130 may be part of a backend computing infrastructure, including a server infrastructure of a company or institution, to which the application 112, the application 162, and the application 172 belong. While the records server 130 is described and shown as a single component in FIG. 1, this is merely an example. In some embodiments, the records server 130 can comprise a variety of centralized or decentralized computing devices. For example, the records server 130 may include a mobile device, a laptop computer, a desktop computer, grid-computing resources, a virtualized computing resource, cloud computing resources, peer-to-peer distributed computing devices, a server farm, or a combination thereof. The records server 130 may be centralized in a single room, distributed across different rooms, distributed across different geographical locations, or embedded within the network 120. While the devices comprising the records server 130 can couple with the network 120 to communicate with the client device 110, the client device 160, and the client device 170, the devices of the records server 130 can also function as stand-alone devices separate from other devices of the system 100.

In several embodiments, if the records server 130 is implemented using cloud computing resources, the cloud computing resources may be resources of a public or private cloud. Examples of a public cloud include, without limitation, Amazon Web Services (AWS)™, IBM Cloud™, Oracle Cloud Solutions™, Microsoft Azure Cloud™, and Google Cloud™. A private cloud refers to a cloud environment similar to a public cloud with the exception that it is operated solely for a single organization.

In several embodiments, the records server 130 can couple to the client device 110 to allow the application 112 to function. For example, in several embodiments, both the client device 110 and the records server 130 can have at least a portion of the application 112 installed thereon as instructions on a non-transitory computer readable medium. The client device 110 and the records server 130 can both execute portions of the application 112 using client-server architectures, to allow the application 112 to function.

In several embodiments, the records server 130 can couple to the client device 160 to allow the application 162 to function. For example, in several embodiments, both the client device 160 and the records server 130 can have at least a portion of the application 162 installed thereon as instructions on a non-transitory computer readable medium. The client device 160 and the records server 130 can both execute portions of the application 162 using client-server architectures, to allow the application 162 to function.

In several embodiments, the records server 130 can couple to the client device 170 to allow the application 172 to function. For example, in several embodiments, both the client device 170 and the records server 130 can have at least a portion of the application 172 installed thereon as instructions on a non-transitory computer readable medium. The client device 170 and the records server 130 can both execute portions of the application 172 using client-server architectures, to allow the application 172 to function.

In several embodiments, the records server 130 can transmit requests and other data to, and receive indications, device attributes, and other data from, the authentication module 114, the authentication module 164, and the authentication module 174 (and in effect the client device 110, the client device 160, and the client device 170, respectively) via the network 120. The network 120 refers to a telecommunications network, such as a wired or wireless network. The network 120 can span and represent a variety of networks and network topologies. For example, the network 120 can include wireless communications, wired communications, optical communications, ultrasonic communications, or a combination thereof. For example, satellite communications, cellular communications, Bluetooth, Infrared Data Association standard (IrDA), wireless fidelity (WiFi), and worldwide interoperability for microwave access (WiMAX) are examples of wireless communications that may be included in the network 120. Cable, Ethernet, digital subscriber line (DSL), fiber optic lines, fiber to the home (FTTH), and plain old telephone service (POTS) are examples of wired communications that may be included in the network 120. Further, the network 120 can traverse a number of topologies and distances. For example, the network 120 can include a direct connection, personal area network (PAN), local area network (LAN), metropolitan area network (MAN), wide area network (WAN), or a combination thereof. For illustrative purposes, in the embodiment of FIG. 1, the system 100 is shown with the client device 110, the client device 160, the client device 170, and the records server 130 as end points of the network 120. This, however, is an example and it is to be understood that the system 100 can have a different partition between the client device 110, the client device 160, the client device 170, the records server 130, the records database 140, the cryptographic database 150, and the network 120. For example, the client device 110, the client device 160, the client device 170, and the records server 130 can also function as part of the network 120.

In several embodiments, the client device 110, the client device 160, and the client device 170 can include at least the authentication module 114, the authentication module 164, and the authentication module 174, respectively. In several embodiments, each of the authentication module 114, the authentication module 164, and the authentication module 174 may be a module of the application 112, the application 162, and the application 172, respectively. In several embodiments, the authentication module 114, the authentication module 164, and the authentication module 174 can enable the client device 110, the client device 160, and the client device 170, respectively, and/or the application 112, the application 162, and the application 172, respectively, to receive requests and other data from, and transmit requests, device attributes, indications, and other data to, the authentication service 132 and/or the records server 130 via the network 120. In several embodiments, this may be done by having the authentication module 114, the authentication module 164, and the authentication module 174 communicatively couple to the authentication service 132 via an API to transmit and receive data as a variable or parameter.

In several embodiments, the records server 130 can include at least the authentication service 132. In several embodiments, the authentication service 132 may be implemented as a software application on the records server 130. In several embodiments, the authentication service 132 can enable the receipt, generation, and/or transmission of one or more service requests 134, one or more invoices 136, and one or more media files 138. This may be done, for example, by having the authentication service 132 couple to the authentication module 114, the authentication module 164, and the authentication module 174 via a respective API. In several embodiments, the authentication service 132 can further enable storage of the one or more service requests 134, one or more invoices 136, and one or more media files 138 in a local storage device. Additionally or alternatively, in several embodiments, the authentication service 132 can further enable transmission (e.g., directly, or indirectly via the network 120) of the one or more service requests 134, one or more invoices 136, and one or more media files 138 to records database 140 for storage and retrieval.

The records database 140 may be a database or repository used to store one or more digital items of record, including digital item of record 142 (e.g., a listing such as a real estate listing), any other suitable data, or any combination thereof. For example, the records database 140 can store, digital item of record 142 and all of the service requests, invoices, and media files associated with the digital item of record 142. In an embodiment, the cryptographic database 140 stores the first unique key 142 and the second unique key in a list or as table entries.

The cryptographic database 150 may be a database or repository used to store one or more cryptographic keys, including first unique key 152, second unique key 154, any other suitable data, or any combination thereof. For example, the cryptographic database 150 can store the first unique key 152 and the second unique key 154, and then destroy one or both of the first unique key 152 and the second unique key 154 as described in further detail herein. In an embodiment, the cryptographic database 150 stores the first unique key 152 and the second unique key in a list or as table entries.

In a variety of embodiments, the authentication service 132 of the records server 130 can provide for authenticating the user 102, the user 104, and/or the user 106 without creating a password-protected account based on one or more unique keys generated by the authentication service 132 of the records server 130 and stored in the cryptographic database 150. For example, the records server 130 can receive, from the client device 160 in response to input from the user 104 (e.g., the digital item of record 142), an electronic request to generate a service request associated with the user 106 (e.g., an entity such as a third-party service provider) and the digital item of record 142 stored in the records database 140. In response, the records server 130 can generate a service request 134 associated with the user 106 and the digital item of record 142 stored in the records database 140. The records server 130 can generate a first unique key 152 associated with the user 106 and the digital item of record 142 and embed the first unique key 152 as a first clickable link in the service request 134. The records server 130 then can transmit the service request 134 to the client device 170 associated with the user 106, who can use the client device 170 to view the service request 134 and approve or accept the service request 134 by clicking on the first clickable link included in the service request 134. As a result, the client device 170 can generate a first electronic indication that the user 106 has clicked the first clickable link and transmit the first electronic indication to the records server 130. The records server 130 can receive the first electronic indication that the user 106 has clicked the first clickable link and, in response, verify that an identity of the user 106 is authentic based on the first unique key 152. In some aspects, the records server 130 can destroy the first unique key 152 in response to verifying that the identity of the user 106 is authentic based on the first unique key 152.

In some aspects, in response to verifying that the identity of the user 106 is authentic based on the first unique key 152, the records server 130 can generate a graphical user interface (GUI) including a vendor dashboard that includes first electronic information associated with the service request 134 and second electronic information associated with the digital item of record 142. The first electronic information associated with the service request 134 can include, for example, a selectable icon to confirm the appointment, a selectable icon to substitute an available date, a selectable icon to accept or book the appointment, a selectable icon to cancel or decline the appointment, a link to add the service request 134 to an electronic calendar, any other suitable electronic information, or any combination thereof. The second electronic information associated with the digital item of record 142 can include, for example, media files or any other suitable electronic information, or any combination thereof. In one illustrative and non-limiting example relating to a real estate context, the digital item of record 142 can include photographs of the property, lock box information, security codes, or government records for the property.

In several embodiments, the records server 130 can generate an invoice 136 (e.g., a draft invoice) for the service request 134. The records server 130 then can generate a second unique key 154 associated with the user 106 and the digital item of record 142 and embed the second unique key 154 as a second clickable link in the invoice 136. The records server 130 can transmit the invoice 136 to the client device 160 associated with the user 104, who can use the client device 160 to view the invoice 136 and approve the invoice 136 by clicking on the second clickable link included in the invoice 136. As a result, the client device 160 can generate a second electronic indication that the user 104 has clicked the second clickable link and transmit the second electronic indication to the records server 130. The records server 130 can receive the second electronic indication that the user 104 has clicked the second clickable link and, in response, verify that an identity of the user 104 is authentic based on the second unique key 154.

In several embodiments, the user 106 can use the client device 170 to upload media files (e.g., floorplans, pictures, videos, etc.) to the records server. For example, the records server 130 can transmit the invoice 136 to the client device 170 associated with the user 106, who can use the client device 170 to view the invoice 136 and upload media files 138 associated with the completion of the service request 134 and the finalization of the invoice 136 by clicking on the second clickable link included in the invoice 136. As a result, the client device 160 can generate a third electronic indication that the user 106 has clicked the second clickable link and transmit the third electronic indication to the records server 130. The records server 130 can receive the third electronic indication that the user 106 has clicked the second clickable link and, in response, verify that an identity of the user 106 is authentic based on the second unique key 154. In some aspects, the records server 130 can receive, from the client device 170, a media upload associated with the service request 134 and store the media upload as one or more media files 138 in association with the digital item of record 142. Subsequently, in response to the receipt of the media upload associated with the service request 134, the records server 130 can convert the invoice 136 from a draft invoice to an active invoice for the service request 134. In some aspects, the records server 130 can destroy the second unique key 154 in response to converting the invoice 136 from a draft invoice to an active invoice.

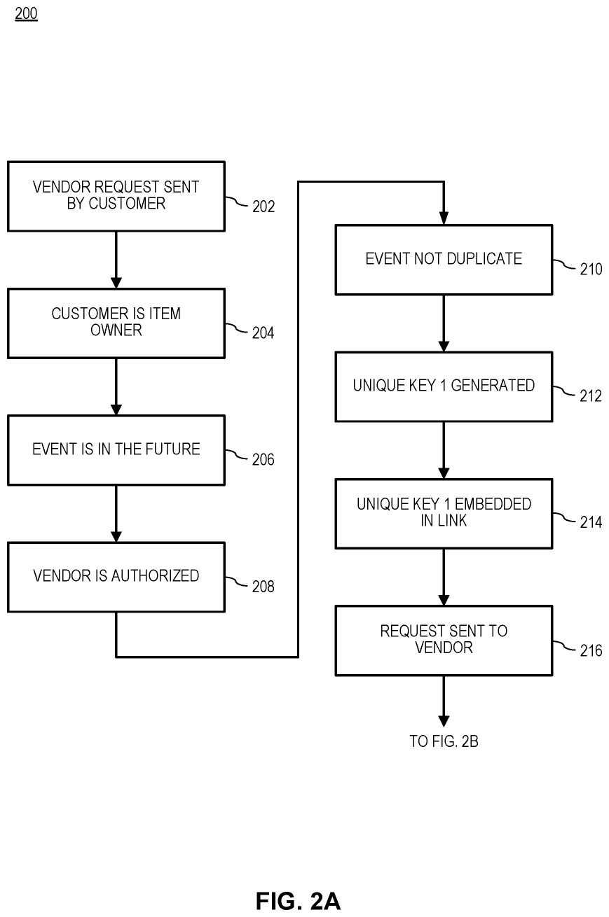

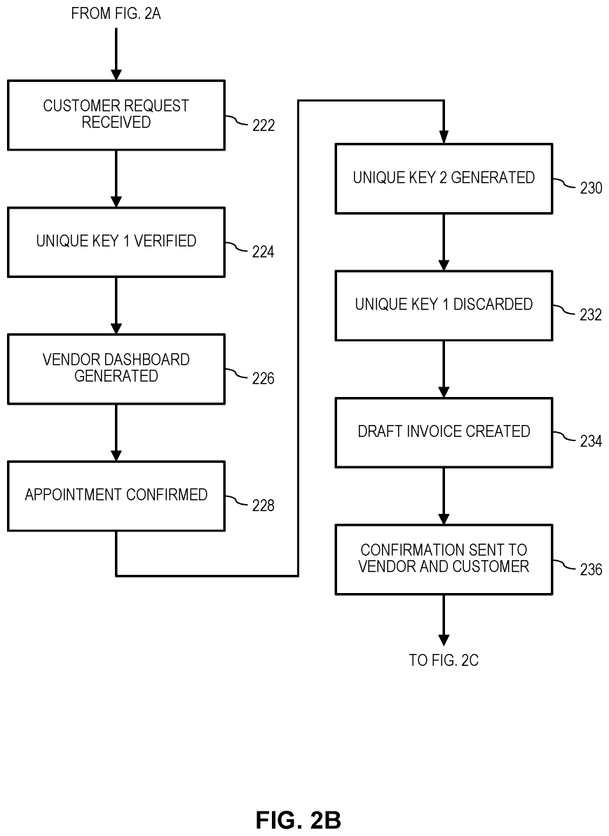

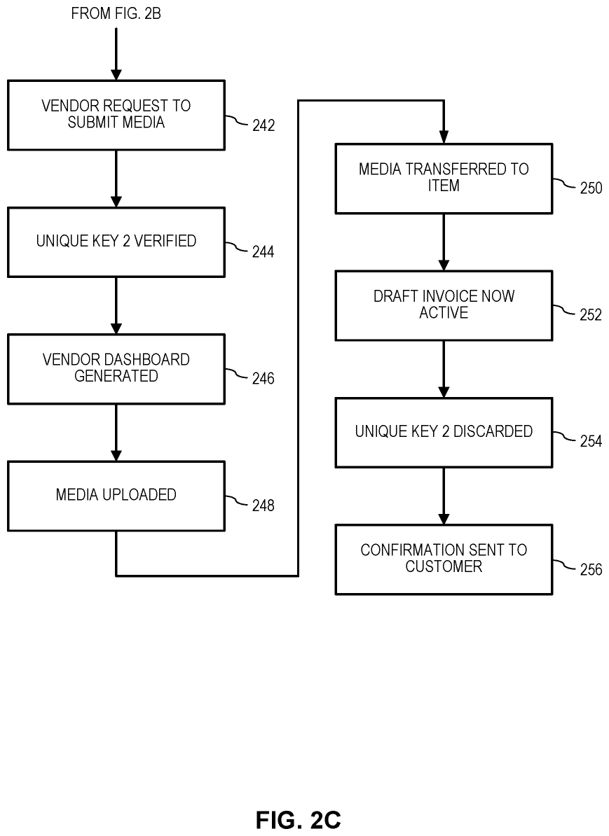

FIGS. 2A, 2B, and 2C show portions of an example process flow 200 for a computing system, such as the system 100 shown in FIG. 1, according to some embodiments. For example, process flow 200 can provide an example of how the system 100 shown in FIG. 1, or any other suitable computing system, can operate. For the purposes of this example discussion of FIG. 2, it is to be understood that some or all of the application 112, including some or all of the authentication module 114, is installed on the client device 110. It is to be further understood that some or all of the application 162, including some or all of the authentication module 164, is installed on the client device 160. It is to be further understood that some or all of the application 172, including some or all of the authentication module 174, is installed on the client device 170. It is to be further understood that the authentication service 132 is installed on the records server 130.

FIG. 2A describes operations relating to a customer or user request for vendor services. At 202, the process flow 200 begins by a customer (e.g., user 102) sending a service request to the records server 130. At 204, if the records server 130 determines that the customer is the item owner, the process flow 200 proceeds to 206. At 206, if the records server 130 determines that the event is in the future, the process flow 200 proceeds to 208. At 208, if the records server 130 determines that the vendor (e.g., user 106) is authorized, the process flow 200 proceeds to 210. At 210, if the records server 130 determines that the event is not a duplicate, the process flow 200 proceeds to 212. At 212, the records server 130 generates a first unique key. At 214, the records server 130 embeds the first unique key in a link in the service request. At 216, the records server 130 sends the service request to the vendor.

FIG. 2B describes operations relating to vendor receipt of the customer or user request for services. At 222, the client device 170 receives the customer's request. At 224, the records server 130 verifies the first unique key. In one embodiment, upon verification of the first unique key, a revalidation of earlier operations from FIG. 2A (e.g., operations 204, 206, and 208) occurs, including by way of non-limiting example reconfirming that the customer is the item owner, reconfirming that the event is in the future, and reconfirming that the requesting vendor is authorized. At 226, the records server 130 generates a vendor dashboard. At 228, the vendor confirms the appointment. At 230, the records server 130 generates a second unique key. At 232 (which may occur before, after, or substantially the same time as 230), the records server 130 discards the first unique key. At 234, the records server 130 creates a draft invoice, if requested or required, in accordance with embodiments. At 236, the records server 130 sends a confirmation of the draft invoice to the vendor and the customer.

FIG. 2C describes operations relating to vendor delivery of media to a customer or user. At 242, the records server 130 receives a request from the vendor to submit media. At 244, the records server 130 verifies the second unique key. At 246, the records server 130 generates the vendor dashboard on the client device 170. At 248, the vendor uses the client device 170 to upload the media files to the records server 130. At 250, the records server 130 transfers the media files to the item (e.g., the digital item of record). At 252, the records server 130 converts the draft invoice to an active invoice, if a draft invoice is present, and in accordance with embodiments where invoices are requested or required. At 254, the records server 130 discards the second unique key. At 256, the records server 130 sends a confirmation to the customer.

The aforementioned process flow 200 may be performed by the modules, units, or services of the client device 110, the client device 160, the client device 170, and the records server 130 and may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as part of the system 100 and/or installed as a removable portion of the system 100. In some aspects, system 100 described above significantly improves the state of the art from previous systems because it provides an enhanced method of performing user authentication. The enhancement stems from the use of unique keys in conjunction with particular digital items of record (e.g., listings) and entities (e.g., vendors) to provide for authenticating users without having to create password-protected accounts (e.g., usernames and passwords). As a result of the faster and simpler (e.g., requiring less computing resources, less user actions, etc.) user authentication techniques described herein, entities are more likely to respond to service requests and submit media (e.g., floorplans, photos, videos, etc. in the non-limiting real estate context) confirming the completion of the service requests.

Additionally, businesses using the authentication processes disclosed herein can continue to leverage their existing software or systems without the need for modifications to the software or other accommodations to integrate a service for managing service requests. And, from the vendor perspective, there is no need to undergo an onboarding process in order to respond to such a service request, which can induce more potential vendors to participate in fulfillment of service requests by placing less strain on vendors' time.

Methods of Operation

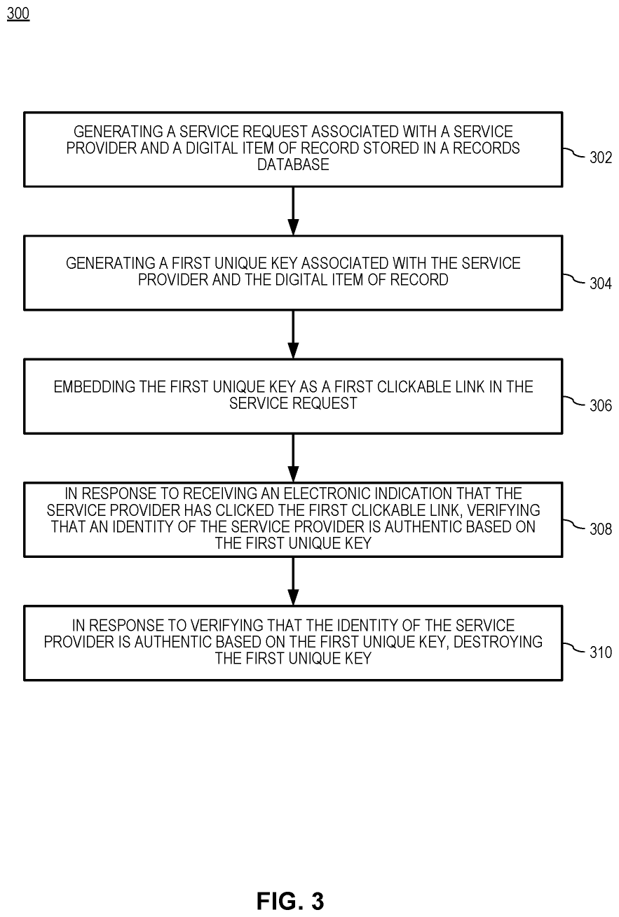

FIG. 3 is an example method 300 of operating the system 100 (and, in some aspects, the process flow 200) to provide for authenticating a user without creating a password-protected account according to some embodiments. For example, method 300 indicates how the records server 130 operates to authenticate a user without creating a password-protected account.

In several embodiments, operation 302 operates to allow the records server 130 to generate (e.g., in response to input from a principal such as user 102) a service request 134 associated with a service provider (e.g., user 106, which may be a particular vendor of services such as real estate services) and a digital item of record 142 (e.g., listing) stored in a records database (e.g., records database 140).

In several embodiments, operation 304 operates to allow the records server 130 to generate a first unique key 152 associated with the service provider and the digital item of record.

In several embodiments, operation 306 operates to allow the records server 130 to embed the first unique key 152 as a first clickable link in the service request 134.

In several embodiments, operation 308 operates to allow the records server 130 to verify that an identity of the entity is authentic and authorized based on the first unique key 152 in response to receiving an electronic indication that the service provider has clicked the first clickable link (e.g., using the client device 170).

In several embodiments, operation 310 operates to allow the records server 130 to destroy the first unique key 152 in response to verifying that the identity of the service provider is authentic.

In some embodiments, operation of method 300 can be performed, for example, by system 100 or the functional units or devices described with reference to process flow 200, in accordance with embodiments described above.

Components of the System

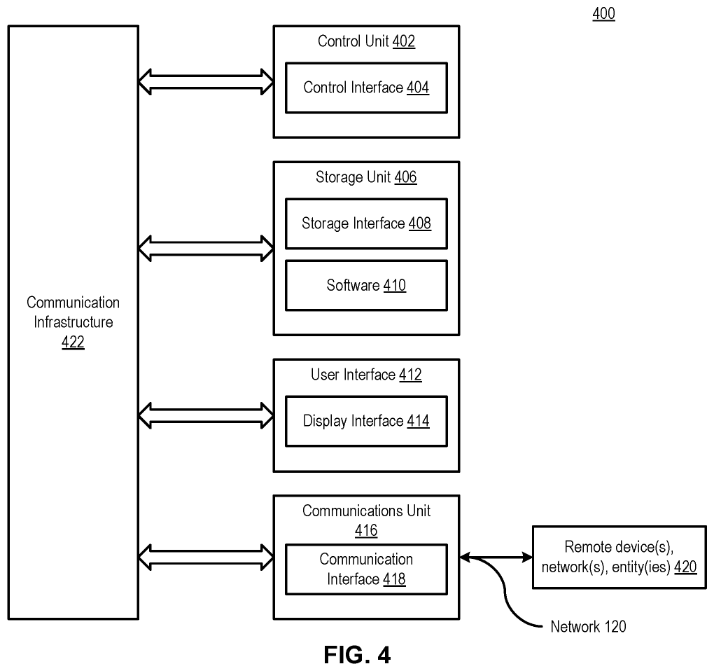

FIG. 4 is an example architecture 400 of components implementing the system 100 according to some embodiments. The components may be implemented by any of the devices described with reference to the system 100, such as the client device 110, the client device 160, the client device 170, the records server 130, the records database 140, the cryptographic database 150, or a combination thereof. The components may be further implemented by any of the devices described with reference to the process flow 200.

In several embodiments, the components may include a control unit 402, a storage unit 406, a communication unit 416, and a user interface 412. The control unit 402 may include a control interface 404. The control unit 402 may execute a software 410 (e.g., the application 112, the authentication module 114, the application 162, the authentication module 164, the application 172, the authentication module 174, the authentication service 132, or a combination thereof) to provide some or all of the machine intelligence described with reference to system 100. In another example, the control unit 402 may execute a software 410 to provide some or all of the machine intelligence described with reference to process flow 200.

The control unit 402 may be implemented in a number of different ways. For example, the control unit 402 may be a processor (such as a central processing unit (CPU) or graphics processing unit (GPU)), an application specific integrated circuit (ASIC), an embedded processor, a microprocessor, a hardware control logic, a hardware finite state machine (FSM), a digital signal processor (DSP), a field programmable gate array (FPGA), or a combination of one or more thereof.

The control interface 404 may be used for communication between the control unit 402 and other functional units or devices of system 100 (e.g., the client device 110, the client device 160, the client device 170, the records server 130, the records database 140, the cryptographic database 150, or a combination thereof) or those described with reference to process flow 200. The control interface 404 may also be used for communication that is external to the functional units or devices of system 100 or those described with reference to process flow 200. The control interface 404 may receive information from the functional units or devices of system 100 or process flow 200, or from remote devices 420, or may transmit information to the functional units or devices of system 100 or process flow 200, or to remote devices 420. The remote devices 420 refer to units or devices external to system 100 or process flow 200.

The control interface 404 may be implemented in different ways and may include different implementations depending on which functional units or devices of system 100, process flow 200, or remote devices 420 are being interfaced with the control unit 402. For example, the control interface 404 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 404 may be connected to a communication infrastructure 422, such as a bus, to interface with the functional units or devices of system 100, process flow 200, or remote devices 420.

The storage unit 406 may store the software 410. For illustrative purposes, the storage unit 406 is shown as a single element, although it is understood that the storage unit 406 may be a distribution of storage elements. Also for illustrative purposes, the storage unit 406 is shown as a single hierarchy storage system, although it is understood that the storage unit 406 may be in a different configuration. For example, the storage unit 406 may be formed with different storage technologies forming a memory hierarchical system including different levels of caching, main memory, rotating media, or offline storage. The storage unit 406 may be a volatile memory, a nonvolatile memory, an internal memory, an external memory, or a combination thereof. For example, the storage unit 406 may be a nonvolatile storage such as nonvolatile random access memory (NVRAM), flash memory, disk storage, or a volatile storage such as static random access memory (SRAM) or dynamic random access memory (DRAM).

The storage unit 406 may include a storage interface 408. The storage interface 408 may be used for communication between the storage unit 406 and other functional units or devices of system 100 or process flow 200. The storage interface 408 may also be used for communication that is external to system 100 or process flow 200. The storage interface 408 may receive information from the other functional units or devices of system 100, process flow 200, or from remote devices 420, or may transmit information to the other functional units or devices of system 100 or to remote devices 420. The storage interface 408 may include different implementations depending on which functional units or devices of system 100, process flow 200, or remote devices 420 are being interfaced with the storage unit 406. The storage interface 408 may be implemented with technologies and techniques similar to the implementation of the control interface 404.

The communication unit 416 may enable communication to devices, components, modules, or units of system 100, process flow 200, or remote devices 420. For example, the communication unit 416 may permit the system 100 to communicate between the client device 110, the client device 160, the client device 170, the records server 130, the records database 140, the cryptographic database 150, or a combination thereof. In another example, the communication unit 416 may permit the functional units or devices described with reference to process flow 200 to communicate between the client device 110, the records server 130, the records database 140, or a combination thereof. The communication unit 416 may further permit the devices of system 100 or process flow 200 to communicate with remote devices 420 such as an attachment, a peripheral device, or a combination thereof through the network 120.

As previously indicated, the network 120 may span and represent a variety of networks and network topologies. For example, the network 120 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 120. Cable, Ethernet, digital subscriber line (DSL), fiber optic lines, fiber to the home (FTTH), and plain old telephone service (POTS) are examples of wired communication that may be included in the network 120. Further, the network 120 may traverse a number of network topologies and distances. For example, the network 120 may include direct connection, personal area network (PAN), local area network (LAN), metropolitan area network (MAN), wide area network (WAN), or a combination thereof.

The communication unit 416 may also function as a communication hub allowing system 100 to function as part of the network 120 and not be limited to be an end point or terminal unit to the network 120. The communication unit 416 may include active and passive components, such as microelectronics or an antenna, for interaction with the network 120.

The communication unit 416 may include a communication interface 418. The communication interface 418 may be used for communication between the communication unit 416 and other functional units or devices of system 100 or to remote devices 420. The communication interface 418 may receive information from the other functional units or devices of system 100, or from remote devices 420, or may transmit information to the other functional units or devices of the system 100 or to remote devices 420. The communication interface 418 may include different implementations depending on which functional units or devices are being interfaced with the communication unit 416. The communication interface 418 may be implemented with technologies and techniques similar to the implementation of the control interface 404.

The user interface 412 may present information generated by system 100. In several embodiments, the user interface 412 allows a user to interface with the devices of system 100 or remote devices 420. The user interface 412 may include an input device and an output device. Examples of the input device of the user interface 412 may include a keypad, buttons, switches, touchpads, soft-keys, a keyboard, a mouse, voice input, or any combination thereof to provide data and communication inputs. Examples of the output device may include a display interface 414. The control unit 402 may operate the user interface 412 to present information generated by system 100. The control unit 402 may also execute the software 410 to present information generated by system 100, or to control other functional units of system 100. The display interface 414 may be any GUI such as a display, a projector, a video screen, or any combination thereof.

The above detailed description and embodiments of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The system 100, the process flow 200, and the method 300, are cost-effective, highly versatile, and accurate, and may be implemented by adapting components for ready, efficient, and economical manufacturing, application, and utilization. Another important aspect of embodiments of the present disclosure is that they valuably support and service the trend of reducing costs, simplifying systems, and/or increasing system performance.

These and other valuable aspects of the embodiments of the present disclosure consequently further the state of the technology to at least the next level. While the disclosed embodiments have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the disclosure is not to be restricted except in light of the attached claims and their equivalents.

What is claimed is:

1. A computer-implemented method, comprising:
generating, by one or more computing devices, a service request associated with a first entity and a digital item of record stored in a records database;
generating, by the one or more computing devices, a first unique key associated with the first entity and the digital item of record;
embedding, by the one or more computing devices, the first unique key as a first clickable link in the service request; and
in response to receiving an electronic indication that the first entity has clicked the first clickable link, verifying, by the one or more computing devices, that an identity of the first entity is authentic based on the first unique key.

2. The computer-implemented method of claim 1, further comprising:
in response to verifying that the identity of the first entity is authentic based on the first unique key, destroying, by the one or more computing devices, the first unique key.

3. The computer-implemented method of claim 1, further comprising:
generating, by the one or more computing devices, a draft invoice for the service request;
generating, by the one or more computing devices, a second unique key associated with the first entity and the digital item of record; and
embedding, by the one or more computing devices, the second unique key as a second clickable link in the draft invoice.

4. The computer-implemented method of claim 3, further comprising:
in response to receiving an electronic indication that a second entity has clicked the second clickable link, verifying, by the one or more computing devices, that an identity of the second entity is authentic based on the second unique key.

5. The computer-implemented method of claim 4, further comprising:
in response to verifying that the identity of the second entity is authentic based on the second unique key, destroying, by the one or more computing devices, the second unique key.

6. The computer-implemented method of claim 3, further comprising:
receiving, by the one or more computing devices and from the service provider, a media upload associated with the service request;
storing, by the one or more computing devices, the media upload in association with the digital item of record;
converting, by the one or more computing devices, the draft invoice to an active invoice for the service request; and
in response to converting the draft invoice to the active invoice, destroying, by the one or more computing devices, the second unique key.

7. The computer-implemented method of claim 1, further comprising:
in response to verifying that the identity of the first entity is authentic based on the first unique key, generating, by the one or more computing devices, a graphical user interface (GUI) comprising an entity dashboard comprising first electronic information associated with the service request and second electronic information associated with the digital item of record.

8. The computer-implemented method of claim 1, wherein the digital item of record is a real estate listing.

9. A non-transitory computer readable medium including instructions for causing a processor to perform operations comprising:
generating a service request associated with a first entity and a digital item of record stored in a records database;
generating a first unique key associated with the first entity and the digital item of record;
embedding the first unique key as a first clickable link in the service request; and
in response to receiving an electronic indication that the first entity has clicked the first clickable link, verifying that an identity of the service provider is authentic based on the first unique key.

10. The non-transitory computer readable medium of claim 9, wherein the operations further comprise:
in response to verifying that the identity of the first entity is authentic based on the first unique key, destroying the first unique key.

11. The non-transitory computer readable medium of claim 9, wherein the operations further comprise:
generating a draft invoice for the service request;
generating a second unique key associated with the first entity and the digital item of record; and
embedding the second unique key as a second clickable link in the draft invoice.

12. The non-transitory computer readable medium of claim 11, wherein the operations further comprise:
in response to receiving an electronic indication that a second entity has clicked the second clickable link, verifying that an identity of the second entity is authentic based on the second unique key.

13. The non-transitory computer readable medium of claim 12, wherein the operations further comprise:
in response to verifying that the identity of the second entity is authentic based on the second unique key, destroying the second unique key.

14. The non-transitory computer readable medium of claim 11, wherein the operations further comprise:
receiving, from the first entity, a media upload associated with the service request;
storing the media upload in association with the digital item of record;
converting the draft invoice to an active invoice for the service request; and
in response to converting the draft invoice to the active invoice, destroying the second unique key.

15. The non-transitory computer readable medium of claim 9, wherein the operations further comprise:
in response to verifying that the identity of the first entity is authentic based on the first unique key, generating a GUI comprising an entity dashboard comprising first electronic information associated with the service request and second electronic information associated with the digital item of record.

16. The non-transitory computer readable medium of claim 9, wherein the digital item of record is a real estate listing.

17. A computing system, comprising:
a storage unit configured to store instructions; and
a control unit coupled to the storage unit and configured to process the stored instructions to perform operations comprising:
generating a service request associated with a first entity and a digital item of record stored in a records database;
generating a first unique key associated with the first entity and the digital item of record;
embedding the first unique key as a first clickable link in the service request; and
in response to receiving an electronic indication that the first entity has clicked the first clickable link, verifying that an identity of the first entity is authentic based on the first unique key.

18. The computing system of claim 17, wherein the operations further comprise:
in response to verifying that the identity of the first entity is authentic based on the first unique key, destroying the first unique key.

19. The computing system of claim 17, wherein the operations further comprise:
generating a draft invoice for the service request;
generating a second unique key associated with the first entity and the digital item of record; and
embedding the second unique key as a second clickable link in the draft invoice.

20. The computing system of claim 17, wherein the digital item of record is a real estate listing.
